(19) United States
(12) Patent Application Publication
(10) Pub. No.: US 2009/0131021 A1
(43) Pub. Date: May 21, 2009

(54) DISTRIBUTION OF AN EMERGENCY WARNING USING PEER-TO-PEER COMMUNICATIONS

(75) Inventors: Jerome O. Vogedes, Milwaukee, WI (US); Daniel A. Baudino, Lake Worth, FL (US); Charles P. Binzel, Bristol, WI (US); Yan Ming Cheng, Inverness, IL (US); Steven J. Nowlan, South Barrington, IL (US); Jorge L. Perdomo, Boca Raton, FL (US); W. Garland Phillips, Lake Barrington, IL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/941,911

(22) Filed: Nov. 16, 2007

(51) Int. Cl. H04L 12/58; H04Q 7/20

(52) U.S. Cl. 455/412.1; 455/422.1

(57) ABSTRACT

A method (400, 500) of propagating an alert (116). The alert can be received on a first communication device (102). The alert can be associated with data indicating at least one peer-to-peer propagation parameter. Further, the alert can be automatically communicated from the first communication device to at least a second communication device in accordance with the peer-to-peer propagation parameter via peer-to-peer communications.

### BACKGROUND OF THE INVENTION

1. Field of the Invention

The present invention generally relates to communication systems and, more particularly, to ad-hoc communications.

2. Background of the Invention

In recent years there has been a concerted effort to reduce the United States' vulnerability to terrorism, minimize losses caused by terrorism, both monetarily and in terms of human suffering, and to improve recovery from attacks that do occur. This effort extends to improving preparedness and responsiveness to natural disasters as well.

One key to achieving the aforementioned goals is to improve dissemination of information to the public when an attack or natural disaster occurs. Currently, the United States relies heavily on the national Emergency Alert System (EAS), which distributes EAS messages over a variety of public broadcast systems (e.g. television and radio broadcasts). The EAS messages typically include an attention signal and an audio announcement containing the information that is being publicly disseminated.

Unfortunately, a large portion of the intended recipients of EAS messages (e.g. persons in the general public) will not have their audio systems and/or televisions turned on when an attack or disaster occurs, and many other intended recipients may not have an audio system or television that is immediately accessible. Accordingly, these persons may not receive the audio announcement, and thus may miss important information and/or instructions that can be used to insure their personal safety.

### SUMMARY OF THE INVENTION

The present invention relates to a method of propagating an alert. The method can include receiving the alert on a first communication device. The alert can be associated with data indicating at least one peer-to-peer propagation parameter. Further, the alert can be automatically communicated from the first communication device to at least a second communication device in accordance with the peer-to-peer propagation parameter via peer-to-peer communications.

Communicating the alert in accordance with the peer-to-peer propagation parameter can include determining whether the first communication device is located within an alert region. Determining whether the first communication device is located within the alert region can include identifying a location of the first communication device and determining whether the distance between the location of the first communication device and a reference location is less than a threshold value.

Communicating the alert in accordance with the peer-to-peer propagation parameter also can include identifying a location of the second communication device and determining whether the second communication device is located within an alert region. In another arrangement, communicating the alert in accordance with the peer-to-peer propagation parameter can include identifying a number of degrees of separation from an alert originator and determining whether the number of degrees of separation has reached a threshold value. Identifying a number of degrees of separation from an alert originator can include identifying a number of times the alert has been communicated along a particular propagation chain.

The method further can include identifying an alert identifier as the peer-to-peer propagation parameter and, based on the peer-to-peer propagation parameter, determining whether another instance of the alert has been received by the first communication device. In such an arrangement, automatically communicating the alert from the first communication device to the second communication device can be performed in response to determining that another instance of the alert has not been received by the first communication device.

The method also can include receiving an alert termination message and, in response to the alert termination message, halting further communication of the alert from the first communication device. The method further can include automatically communicating the alert termination message from the first communication device to the second communication device via peer-to-peer communications. In another arrangement, an indicator of a time when to end propagation of the alert can be received, and further communication of the alert from the first communication device can be halted at the indicated time.

The present invention also relates to a method of propagating an alert, which can include identifying an alert region, associating the alert with at least one peer-to-peer propagation parameter. The method further can include identifying at least one communication device located in the alert region and being configured to communicate using peer-to-peer communications, and communicating the alert to the communication device.

Generating the alert to include at least one peer-to-peer propagation parameter can include generating the alert to identify the alert region. Generating the alert to include at least one peer-to-peer propagation parameter also can include generating the alert to identify a number of degrees of separation from an alert originator that the alert is to be passed using peer-to-peer communications.

In another arrangement, generating the alert to include at least one peer-to-peer propagation parameter can include generating the alert to identify an alert identifier. The method further can include determining whether the alert is still required in the alert region. Responsive to determining that the alert is no longer required in the alert region, an alert termination can be communicated to the communication device.

The present invention also relates to a communication device that includes a controller that receives an alert, the alert associated with data indicating at least one peer-to-peer propagation parameter. The controller can automatically communicate the alert via peer-to-peer communications from the communication device to at least a second communication device in accordance with the peer-to-peer propagation parameter. In one arrangement, the controller can determine whether the communication device is located within an alert region. The controller also can indentify a location of the communication device and determine whether the distance between the location of the communication device and a reference location is less than a threshold value.

Further, the controller can identify a location of the second communication device and determine whether the second communication device is located within an alert region. The controller also can identify a number of degrees of separation from an alert originator and determine whether the number of degrees of separation has reached a threshold value.

### BRIEF DESCRIPTION OF THE DRAWINGS

Preferred embodiments of the present invention will be described below in more detail, with reference to the accompanying drawings, in which:

FIG. 1 depicts a communication system that is useful for understanding the present invention;

FIG. 2 depicts a geographic region that is useful for understanding the present invention; and

FIG. 3 depicts a communication device that is useful for understanding the present invention;

FIG. 4 is a flowchart presenting a method of propagating an alert that is useful for understanding the present invention; and

FIG. 5 is another flowchart presenting a method of propagating an alert that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for propagating an alert among a plurality of communication devices, for example mobile communication devices. Accordingly, the alert can be transmitted to users who may not have immediate access to radio or television broadcast signals. Moreover, the alert can be successively propagated among communication devices using peer-to-peer communications, thus enabling the alert to be disseminated among a large number of communication devices with minimal use of network infrastructure.

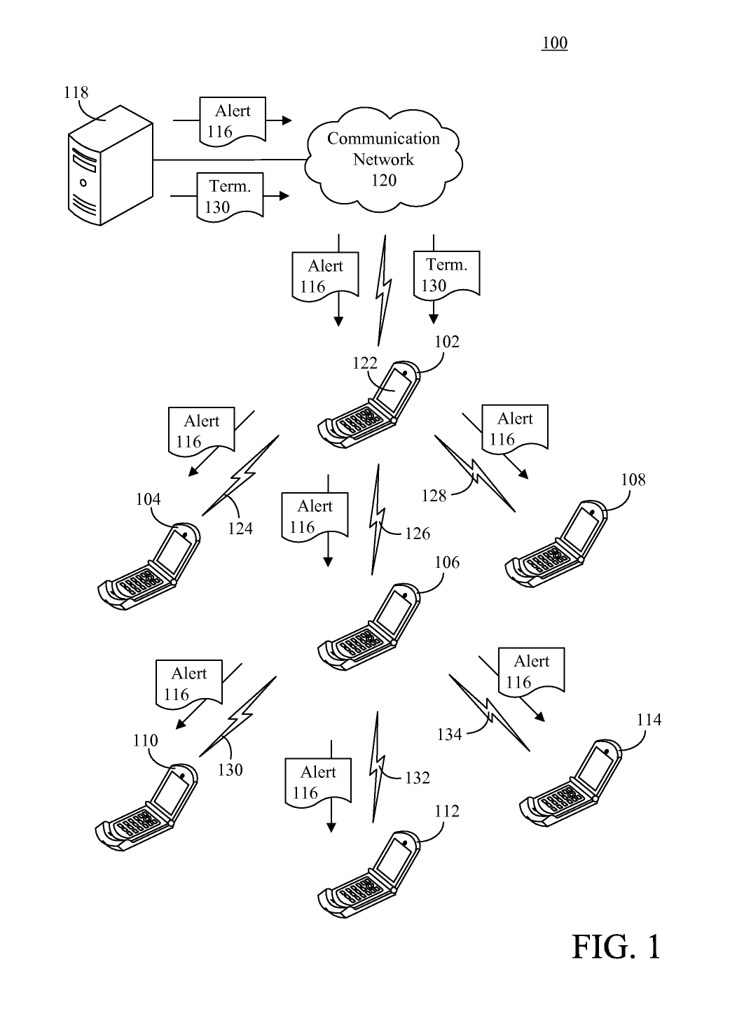

FIG. 1 depicts a communication system 100 that is useful for understanding the present invention. The communication system 100 can include a plurality of communication devices 102, 104, 106, 108, 110, 112, 114. The communication devices 102-114 can be mobile stations (e.g. mobile telephones, mobile radios, mobile computers, personal digital assistants, or the like), computers, wireless gaming devices, access terminals, subscriber stations, gaming consoles, televisions, set top boxes, wireless routers, user equipment, or any other suitably configured devices. As such, the communication devices 102-114 can comprise one or more processors/controllers, data storage devices, user interfaces, transceivers, and/or other suitable components.

The communication devices 102-114 can be configured to communicate using peer-to-peer communications. As used herein, the term “peer-to-peer communications” means communications among peer nodes of a communications network. That is, communication signals can be directed from one peer node to another peer node without first being routed to a server. Peer-to-peer communications are well known to the skilled artisan. Examples of communication protocols that support peer-to-peer communications include, but are not limited to, IEEE 802 wireless communications, for example, 802.11 (e.g. Wi-Fi), 802.15, 802.16 (e.g. WiMAX) and 802.20, BlueTooth® and ZigBee®. Still, peer-to-peer communications may be implemented with any other suitable communication protocols and the invention is not limited in this regard.

At least one of the communication devices 102-114, for instance the communication device 102, can be configured to receive an alert 116 from an alert server 118 via a communications network 120. The alert server 118 also can comprise one or more processors/controllers, data storage devices and/or other suitable components, and can be configured to generate the alert 116.

The alert 116 can comprise an Emergency Alert System (EAS) message which, as noted, may include an attention signal and an audio announcement containing the information that is being publicly disseminated. The alert 116 also can include other data and/or information, for example metadata, a uniform resource identifier (URI), etc. The URI can be selected to establish a communication link with a web site, open an application, initiate television or radio broadcast reception, or the like. Further, the alert 116 also may comprise an indicator contained in a header, body and/or footer of the alert 116 that indicates a priority level for the alert 116. Still, any other information and/or indicators can be included with the alert 116 and the invention is not limited in this regard.

The communications network 120 can be implemented in accordance with any suitable communications standards, protocols, and/or architectures, or a suitable combination of such standards, protocols, and/or architectures. For example, the communications network 120 can comprise the Internet, the World Wide Web, a wide area network (WAN), a local area network (LAN), an interconnect communications network (e.g. a cellular communications network), a dispatch communications network, a public safety network, a public switched telephone network (PSTN), and/or any other networks or systems over which communication signals can be propagated. In that regard, the communications network 120 can include wired and/or wireless communication links.

Although the communication devices 104-114 also can be configured to communicate via the communications network 120, this need not be the case. For example, one or more of the communication devices 104-120 may have network presence established via another communications network (not shown), or may not have established network presence with any communications network. Indeed, one or more of the communication devices 104-120 can be configured exclusively for direct peer-to-peer wireless communication with other communication devices.

The communication device 102 can be selected to receive the alert 116 in any suitable manner. For example, the communication device 102 can be selected if it is presently located within an alert region. In one arrangement, the present location of the communication device 102 can be indicated by a positioning system, such as a global positioning system (GPS) or a local positioning system. In another arrangement, the present location of the communication device 102 can be identified based upon the locations of one or more base transceiver stations, repeaters or access points via which the communication device 102 has established presence on a communications network. The present location of the communication device 102 also can be identified using any other suitable techniques, and the invention is not limited in this regard.

In another aspect of the inventive arrangements, if the precise location of the communication device 102 is unknown to the alert server 118, the communication device 102 can be selected to receive the alert 116 based on an approximation of the communication device's location (e.g. based upon which access point the communication device 102 has established network presence). Upon receiving the alert 116, the communication device 102 can determine whether it is presently located in the alert region. If not, the communication device 102 can ignore the alert 116.

If the communication device 102 is located in the alert region, upon receiving the alert 116 from the alert server 118 the communication device 102 can present the alert 116 to a user. For example, the communication device 102 can audibly present the alert 116, visually present the alert 116 and/or present the alert 116 with a haptic response (e.g. a vibration). For instance, in response to receiving the alert 116, the communication device 102 can present an alert ringtone and/or alert vibration, and present text and/or video pertaining to the alert on a display 122. Still, the alert can be presented in any other suitable manner. The communication device 102 also can respond to the alert 116 by communicating a confirmation or an acknowledgement to the alert server 118 to indicate that the alert 116 has been received.

The communication device 102 also can propagate the alert 116 to one or more other communication devices 104-108 over peer-to-peer communication links 124, 126, 128. In one arrangement, such propagation can be conditional upon the communication device 102 being located in the alert region and/or conditional upon other propagation parameters, as will be described, though this need not be the case. The peer-to-peer communication links 124-128 can be direct communication links between the communication device 102 and the respective communication devices 104-108, or can be communication links that are supported using one or more routers, switches and/or access points. In one arrangement, the peer-to-peer communication links 124-128 can be ad-hoc communication links. As used herein, the term “ad-hoc communication link” means a temporary and/or spontaneous communication link that is established between at least two communication devices based, at least in part, on present locations of the communication devices and/or proximity of the communication devices to one another.

By way of example, the communication links 124-128 can be established in response to the alert 116 being received by the communication device 102. For instance, in response to receiving the alert 116 from the alert server 118, the communication device 102 can broadcast an RF signal indicating that the communication device 102 is available for communication. In another arrangement, one or more of the communication devices 102-108 can continuously or periodically broadcast such signals for detection by other communication devices. When a communication device 102-108 detects a signal indicating another communication device is available for communication, the communication device 102-108 can respond with its own RF signal(s) to initiate establishment of a respective communication link 124-128. In yet another arrangement, the communication devices 102-108 can automatically establish presence on an ad-hoc communications network (e.g. LAN or WAN) that supports peer-to-peer communications. Signaling exchanges to establish the peer-to-peer communication links 124-128 can be implemented in accordance with any suitable protocols, and such protocols are well known to those skilled in the art.

In response to receiving the alert 116, the respective communication devices 104-108 can present the alert 116 to respective users, generate suitable confirmations or acknowledgements, and propagate the alert 116 to one or more additional communication devices. For example, the communication device 106 can propagate the alert 116 to the communication devices 110-114 over peer-to-peer communication links 130, 132, 134. In response, the communication devices 110-114 can propagate the alert 116 to one or more other communication devices, and so on.

Propagation of the alert 116 can continue in accordance with one or more peer-to-peer propagation parameters. The peer-to-peer propagation parameters can be indicated by data associated with the alert 116, for example data contained in the alert or another message propagated with the alert. Such other message can be propagated when, before or after the alert 116 is propagated.

In one aspect of the inventive arrangements, the peer-to-peer propagation parameters can indicate a maximum number of degrees of separation between the device presently receiving the alert 116 and the alert server 118, or a maximum number of degrees of separation between the device presently receiving the alert 116 and the communication device 102 that first received the alert. As used herein, the term “degrees of separation” means the number of times a particular alert has been communicated along a particular propagation chain, for example from the server 118 to the communication device 102, then to the communication device 106, then to the communication device 112, and so on. For instance, if in the present example the peer-to-peer propagation parameters indicate that the maximum number of degrees of separation is three, successive propagation of the alert 116 can end at the communication devices 110-114, as well as communication devices (not shown) receiving the alert 116 from the communication devices 104, 108. To end successive propagation of the alert 116, each of the communication devices 110-114 can halt further communication of the alert 116.

The degrees of separation can be tracked in any suitable manner. For instance, the peer-to-peer propagation parameters can include a counter that is incremented or decremented by one each time the alert is communicated to a communication device 102-114, and successive propagation of the alert 116 can end when the counter has reached a threshold value. By way of example, the threshold value can be zero if the counter is being decremented or three if the counter is being incremented. In that regard, the communication devices 102-114 can be configured to evaluate the counter when determining whether to continue successive propagation of the alert 116 to other communication devices.

In another aspect of the inventive arrangements, the peer-to-peer propagation parameters can include an indicator of a time when to end successive propagation of the alert 116. The indicator can indicate the start time and the period to continue propagating the alert 116, an end time, a timer, or any other time indicator. In such an arrangement, the communication devices 102-114 can be configured to end successive propagation of the alert 116 at the indicated time.

In another arrangement, each of the communication devices 102-114 can be configured to halt successive communication of the alert 116 in response to receiving a second instance of the alert 116. For example, after receiving from the communication device 102 a first instance of the alert 116, the communication device 106 can propagate the alert 116 to other communication devices 110-114, as discussed. Further, the communication device 106 can continue to communicate the alert 116 to other communication devices with which it establishes peer-to-peer communication links. However, in response to the communication device 106 receiving another instance of the alert 116 from another communication device, such as the communication device 108, the communication device 106 can terminate its process of successively propagating the alert 116.

In yet another arrangement, an alert termination message 130 can be generated by the alert server 118 when it is desired to end successive propagation of the alert 116. The alert termination message 130 can include a unique identifier that identifies the alert 116. For example, the identifier can match an alert identifier contained in the alert's propagation parameters. The alert termination 130 can be propagated among the communication devices 102-114 in the manner previously described for propagation of the alert 116. Alternatively, the alert termination message 130 can be communicated from the communications network 120 directly to each of the communication devices 102-114. The manner in which the alert 116 is successively propagated also can be based, at least in part, upon the respective locations of the communication devices 102-114.

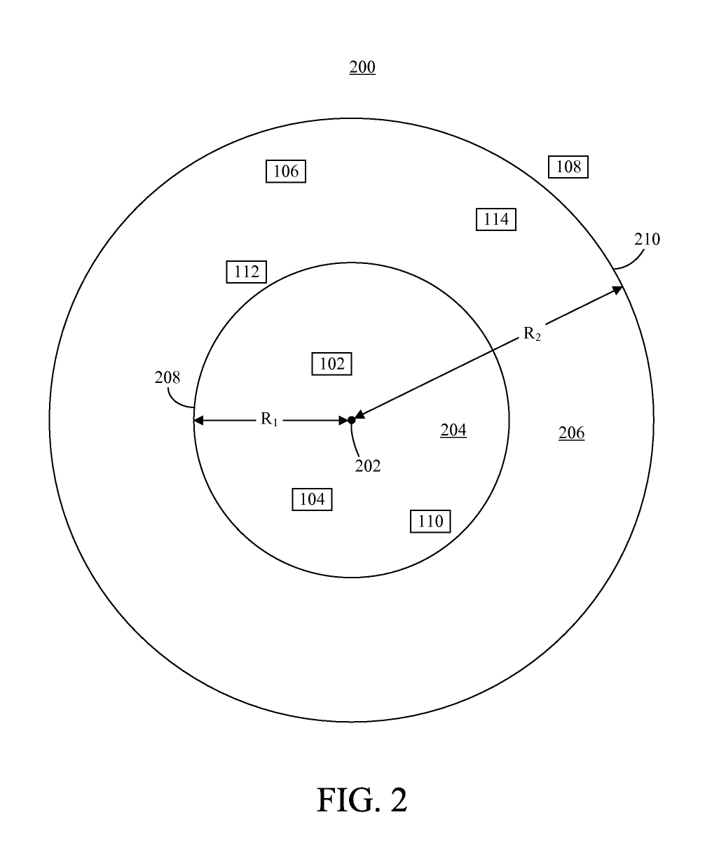

FIG. 2 depicts a geographic region 200 that is useful for understanding such an arrangement. The geographic region 200 can be defined by a geographic center 202 and alert regions 204, 206 surrounding the geographic center 202. The alert regions 204, 206 can be defined, for instance, by radii as measured from the geographic center 202. For example, the alert region 204 can be an area within a boundary 208 defined by a first radius R₁ as measured from the geographic center 202. The alert region 206 can be an area outside the boundary 208, but within a boundary 210 defined by a second radius R₂.

The alert regions 204, 206 also can be defined based on other geographic information. For instance, the alert region 204 can be a village, city, county, state, etc. The alert region 204 also can be a region defined by a particular postal zip code or telephone dialing area code. In either case, the alert region 206 can be a region immediately surrounding the alert region 204. In another arrangement, the alert region 204 can be defined by a high probability projected path of a tornado, hurricane or other storm, while the alert region 206 can be a projected path with lower probability. Still the alert regions 204, 206 can be defined in any other suitable manner and the invention is not limited in this regard.

When establishing the peer-to-peer communication links among the various communication devices 102-114, their respective current locations can be identified. For example, each of the communication devices 102-114 can indicate its current location to other communication devices 102-114 with which peer-to-peer communication links are established. In another arrangement, each of the communication devices 102-114 can identify an approximate location of another communication device 102-114 based on address information contained in one or more messages received from the other communication device 102-114. Location information for the various communication devices 102-114 also can be received from network infrastructure, for example from a server, a base station controller, or the like.

In operation, the alert server can identify that the communication device 102 is currently located within the alert region 204 targeted to receive an alert. For example, the alert server can determine that the present location of the communication device 102 is a distance from the geographic center 202 that is less than a threshold value (e.g. less than R1). Accordingly, the alert server can communicate the alert to the communication device 102. Optionally, the alert server also can communicate the alert to one or more other communication devices 104, 110 located within the alert region 204, although for the remainder of this example it will be assumed that the initial alert was communicated only to the communication device 102. The alert can identify in the peer-to-peer propagation parameters the geographic center 202 and the radii R₁, R₂, thereby indicating the alert regions 204, 206 to the communication device 102. The alert regions 204, 206 also can be indicated in any other suitable manner.

In response to receiving the alert, the communication device 102 can forward the alert to any other communication devices located in the alert regions 204, 206 with which the communication device 102 has established a peer-to-peer communication link. For example, if the communication device 102 has established peer-to-peer communication links with the communication devices 104, 106, 108, the alert can be communicated to the communication devices 104, 106. In one arrangement, because the communication device 108 is not located in either the alert region 204 or the alert region 206, the communication device need not communicate the alert to the communication device 108. Alternatively, because the communication device 102 is located within the alert region 204 and the communication device 108 has established a peer-to-peer communication link with the communication device 102, the alert still can be communicated to the communication device 108.

As noted, the communication devices 104-108 can respond to the alert by forwarding the alert to other communication devices. Because the communication device 104 is located in the alert region 204, the communication device 104 can propagate the alert to other communication devices, regardless of which direction such communication devices are located with respect to the direction of the geographic center 202 (e.g. as measured from the communication device 104). For instance, the communication device 104 can communicate the alert to the communication device 110, which may be located in the alert region 204 but, with respect to the communication device 104, located away from the geographic center 202.

Being located in the alert region 206, the communication device 106 may communicate the alert to communication devices, such as the communication device 112, that are located in the general direction of the geographic center 202 as measured from the communication device 106. Thus, even though the communication device 114 may be located in the alert region 206, because the communication device 114 is not located in the general direction of the geographic center 202 as measured from the communication device 106, the communication device 106 need not communicate the alert to the communication device 114.

In the present example, the communication device 108 is located outside of the alert region 206. Thus, it may be configured to ignore the alert or to present the alert to a user, but not continue to propagate the alert. In another arrangement, the communication device 108 can be configured to propagate the alert to communication devices, such as the communication device 114, that are located between the communication device 108 and the geographic center 202. Optionally, such communication devices can be limited to those that are located in the alert regions 204, 206.

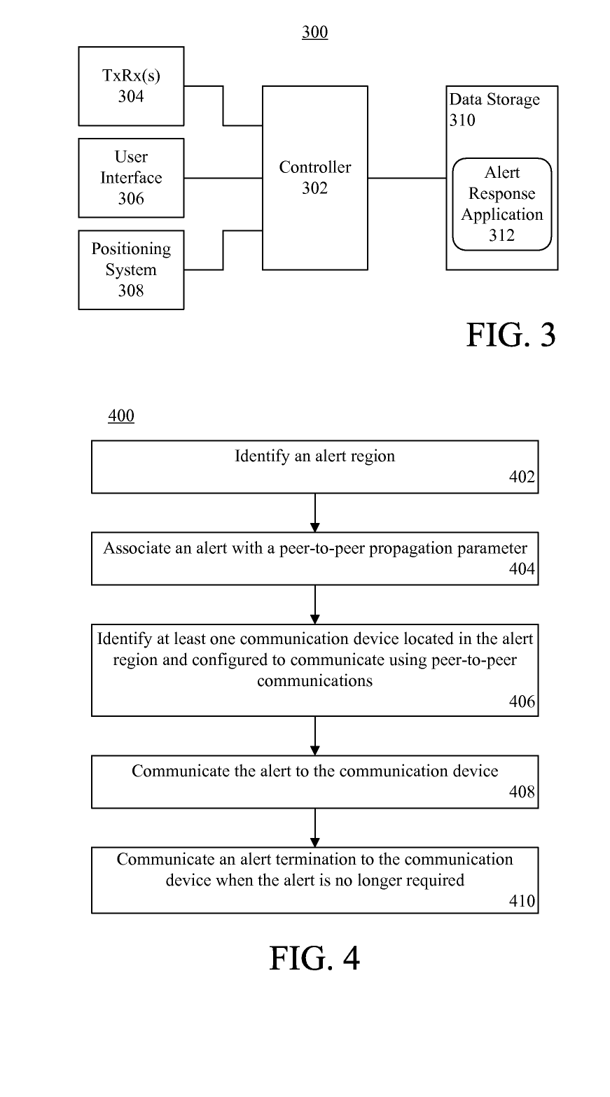

FIG. 3 depicts a communication device 300 that is useful for understanding the present invention. The communication device can include a controller 302, which can be any suitable processing system or group of processing systems. For example, the controller 302 can comprise one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The communication device 300 also can include one or more transceivers 304, which can send and receive wireless communications according to any of a variety of communication standards and/or protocols. For example, the transceiver(s) 304 can be configured to communicate with network infrastructure GSM, TDMA, CDMA, WCDMA, OFDM, etc. Further, the transceiver(s) 304 can be configured to communicate with other communication devices using one or more suitable peer-to-peer communication protocols, for example IEEE 802 wireless communications, BlueTooth® and/or ZigBee®. Modifications or deviations from the standards and/or protocols can be made to suitably implement the present invention. In one arrangement, a first of the transceivers 304 can be provided to communicate with network infrastructure, while a second of the transceivers 304 is provided to support peer-to-peer communications. One skilled in the art will appreciate that the invention is not limited in this regard, however.

A user interface 306 also can be provided. The user interface 306 can include any suitable user interface devices, examples of which include, but are not limited to, displays, touch screens, keys, soft keys, key pads, buttons, haptic devices (e.g. vibration modules), input audio transducers, output audio transducers, headsets, and the like. The communication device 300 also can include a positioning system 308, for example a GPS and/or a local positioning system.

The communication device 300 also can include a data storage 310. The data storage 310 can include one or more storage devices, each of which may include, but is not limited to, a magnetic storage medium, an electronic storage medium, an optical storage medium, a magneto-optical storage medium, and/or any other storage medium suitable for storing digital information. In one arrangement, the data storage 310 can be integrated into the controller 302, though this need not be the case.

An alert response application 312 can be stored on the data storage 310. The alert response application 312 can be executed by the controller 302 to implement the methods and processes described herein which may be performed by a communication device. For example, the controller 302 can receive an alert via at least one of the transceivers 304 and present the alert via the user interface 306. The controller 302 also can establish peer-to-peer communication links with other communication devices via at least one of the transceiver(s) 304, and propagate the alert to one or more of such communication devices. The controller 302 also can receive location information from the positioning system 308, process the location information to determine whether the communication device 300 is located in an alert region, and communicate such location information to other communication devices and/or to network infrastructure.

FIG. 4 is a flowchart presenting a method 400 of propagating an alert that is useful for understanding the present invention. At step 402 an alert region can be identified in response to a determination being made that an alert is to be generated. The alert region can be determined based upon a type of alert being generated. For example, if the alert is an America's Missing: Broadcast Emergency Response (AMBER) alert, the alert region can include one or more villages, cities, counties and/or states. If the alert is a hurricane or tornado alert, the alert region can include areas in or near the projected path of the hurricane or tornado. Further, if the alert is a terrorism alert, the alert region can include geographic regions likely to be impacted by the act of terrorism. Still, the alert region can be selected in any other suitable manner.

At step 404 an alert can be associated with a peer-to-peer propagation parameter. As noted, the peer-to-peer propagation parameter can be a maximum number of degrees of separation between the alert and a server generating the alert, a time when to end the alert, or another indicator of when to end propagation of the alert. At step 406 at least one communication device located in the alert region and configured to communicate using peer-to-peer communications can be identified. Continuing to step 408, the alert can be propagated from an alert server to the communication device. Optionally, at step 410 an alert termination can be communicated to the communication device when the alert is no longer required. Alternatively, the propagation parameters can be relied upon to terminate propagation of the alert.

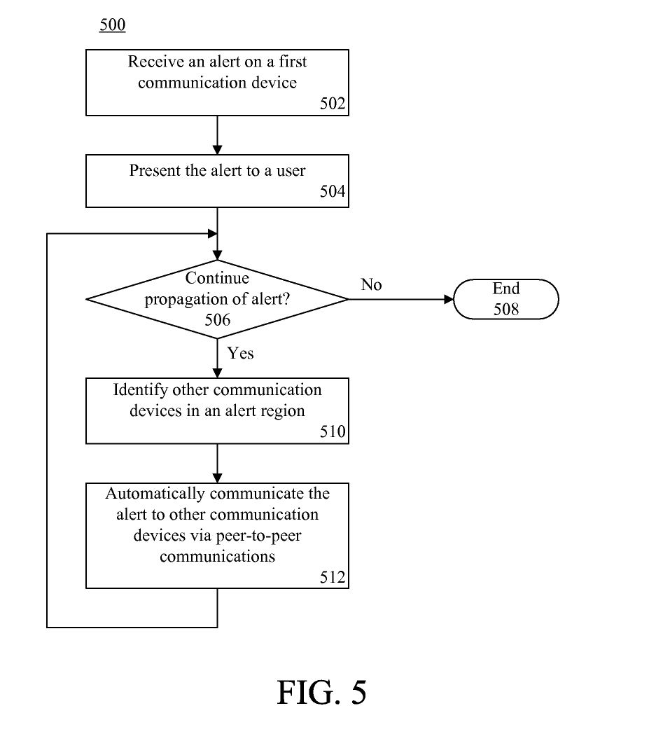

FIG. 5 is another flowchart presenting a method 500 of propagating an alert that is useful for understanding the present invention. At step 502, a first communication device can receive an alert from an alert server or from another communication device, and process the alert accordingly using known demodulation and/or decryption techniques. The alert can be associated with data indicating at least one peer-to-peer propagation parameter. Such data can be included in the alert, or received in a message associated with the alert. At step 504, the alert can be presented to a user of the communication device, for instance via a user interface.

Referring to decision box 506, the communication device can determine whether to continue propagation of the alert. If the communication device determines not to continue propagation of the alert, the process can end at step 508. Determination of whether to continue propagation of the alert can be made in any suitable manner. For example, the peer-to-peer propagation parameters can identify a maximum degree of separation between the communication device and the alert originator (e.g. the alert server) and how many times the alert has been communicated along the propagation chain between the alert originator and the communication device. In response to receiving the alert, the communication device can determine whether the number of times the alert has been communicated along the propagation chain has reached a threshold value equal to or exceeding the maximum degrees of separation. In other arrangements the communication device can determine not to continue propagation of the alert in response to determining that the communication device is not located in the alert region, in response to receiving an alert terminator or a second instance of the alert, or in response to expiration of a time period associated with the alert.

If at decision box 506 it is determined to continue propagating the alert, at step 510 the communication device can identify one or more other communication devices in an alert region. As noted, such alert region can be defined by the peer-to-peer propagation parameters and can be defined in any suitable manner. At step 512 the communication device can automatically communicate the alert to the other communication devices via peer-to-peer communications. Such communication can be in accordance with the peer-to-peer propagation parameters. The process can return to decision box 506 and continue until it is determined not to continue propagation of the alert.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

What is claimed is:

1. A method of propagating an alert, comprising:
receiving the alert on a first communication device, the alert associated with data indicating at least one peer-to-peer propagation parameter; and
automatically communicating the alert from the first communication device to at least a second communication device in accordance with the peer-to-peer propagation parameter via peer-to-peer communications.

2. The method of claim 1, wherein communicating the alert in accordance with the peer-to-peer propagation parameter comprises determining whether the first communication device is located within an alert region.

3. The method of claim 2, wherein determining whether the first communication device is located within the alert region comprises:
identifying a location of the first communication device; and
determining whether the distance between the location of the first communication device and a reference location is less than a threshold value.

4. The method of claim 1, wherein communicating the alert in accordance with the peer-to-peer propagation parameter comprises:
identifying a location of the second communication device; and
determining whether the second communication device is located within an alert region.

5. The method of claim 1, wherein communicating the alert in accordance with the peer-to-peer propagation parameter comprises:
identifying a number of degrees of separation from an alert originator; and
determining whether the number of degrees of separation has reached a threshold value.

6. The method of claim 5, wherein identifying a number of degrees of separation from an alert originator comprises identifying a number of times the alert has been communicated along a particular propagation chain.

7. The method of claim 1, further comprising:
identifying an alert identifier as the peer-to-peer propagation parameter; and
based on the peer-to-peer propagation parameter, determining whether another instance of the alert has been received by the first communication device;
wherein automatically communicating the alert from the first communication device to the second communication device is performed in response to determining that another instance of the alert has not been received by the first communication device.

8. The method of claim 1, further comprising:
receiving an alert termination message; and
in response to the alert termination message, halting further communication of the alert from the first communication device.

9. The method of claim 8, further comprising:
automatically communicating the alert termination message from the first communication device to the second communication device via peer-to-peer communications.

10. The method of claim 1, further comprising:
receiving an indicator of a time when to end propagation of the alert; and
halting further communication of the alert from the first communication device at the indicated time.

11. A method of propagating an alert, comprising:
identifying an alert region;
associating the alert with at least one peer-to-peer propagation parameter;
identifying at least one communication device located in the alert region and being configured to communicate using peer-to-peer communications; and
communicating the alert to the communication device.

12. The method of claim 11, wherein generating the alert to comprise at least one peer-to-peer propagation parameter comprises generating the alert to identify the alert region.

13. The method of claim 11, wherein generating the alert to comprise at least one peer-to-peer propagation parameter comprises generating the alert to identify a number of degrees of separation from an alert originator that the alert is to be passed using peer-to-peer communications.

14. The method of claim 11, wherein generating the alert to comprise at least one peer-to-peer propagation parameter comprises generating the alert to identify an alert identifier.

15. The method of claim 14, further comprising:
determining whether the alert is still required in the alert region; and
responsive to determining that the alert is no longer required in the alert region, communicating an alert termination to the communication device.

16. A communication device, comprising:
a controller that receives an alert, the alert associated with data indicating at least one peer-to-peer propagation parameter, and automatically communicates the alert via peer-to-peer communications from the communication device to at least a second communication device in accordance with the peer-to-peer propagation parameter.

17. The communication device of claim 16, wherein the controller determines whether the communication device is located within an alert region.

18. The communication device of claim 17, wherein the controller identifies a location of the communication device and determines whether the distance between the location of the communication device and a reference location is less than a threshold value.

19. The communication device of claim 16, wherein the controller identifies a location of the second communication device and determines whether the second communication device is located within an alert region.

20. The communication device of claim 16, wherein the controller identifies a number of degrees of separation from an alert originator and determines whether the number of degrees of separation has reached a threshold value.
